(19) United States
(12) Patent Application Publication
(10) Pub. No.: US 2026/0208457 A1
(43) Pub. Date: Jul. 23, 2026

(54) METHOD OF HEATING AN OPTICAL ELEMENT

(71) Applicant: Essilor International, Charenton-le-Pont (FR)

(72) Inventors: Stélie GIRARD, Paris (FR); Sebastien MAURICE, Paris (FR)

(21) Appl. No.: 19/138,760

(22) PCT Filed: Dec. 12, 2023
(86) PCT No.: PCT/EP2023/085430

§ 371 Date: Jun. 13, 2025

(30) Foreign Application Priority Data
Dec. 15, 2022 (EP) 22306893.3

(51) Int. Cl. B29D 11/00; B23K 26/073; B23K 26/324; B23K 26/352; B23K 101/34; B23K 103/00; G02B 1/04

(52) U.S. Cl. CPC B29D 11/0073; B23K 26/073; B23K 26/324; B23K 26/352; B29D 11/00442; B29D 11/00644; G02B 1/041; B23K 2101/35; B23K 2103/30

(57) ABSTRACT

A method of heating an optical element (10) uses a laser beam (B′) and a beam shaping device (2). The beam shaping device is adapted with respect to geometry parameters of the optical element for providing the laser beam with a transverse power distribution (P(r)) such that irradiation of a surface(S) of the optical element causes a temperature of said surface to increase up to a maximum temperature distribution that is substantially uniform throughout said surface. Such heating method provides improved temperature uniformity and allows reduced unit process time. It may be used for tinting an eyeglass, relaxing stresses within a preformed film structure, or cross-linking a varnish layer intended to form a hard coat on an eyeglass.

The invention relates to a method of heating an optical element, a system for implementing such method and a tinted, polarized and/or varnished optical element produced using the method.

### BACKGROUND OF THE INVENTION

Several processes involved in the manufacturing of optical elements such as eyeglasses require heating an optical element together with meeting requirements including processing time, uniformity of the temperature throughout part of the element, control of maximum temperature, etc. For example, tinting an eyeglass may be achieved by first depositing dyes on a surface of the eyeglass and then heating it for fixing the dyes on or into the eyeglass surface.

Using a furnace for performing such heating of the eyeglass leads to heating not only the surface of the eyeglass but also its whole body. But this may not be compatible with composite structures of the eyeglass when it incorporates a portion, for example a polarizing film, which is damaged by temperature values such as necessary for dye fixing. In addition, heating the whole body of the eyeglass requires a process time that is long enough.

EP 2 532 781 A1 teaches heating the surface of the eyeglass by scanning it with the laser beam along a scan path that navigates throughout this whole surface. But such heating method has the following drawbacks:
due to the scanning time involved for each eyeglass to be processed, the unit processing time that is necessary for heating each eyeglass up to the desired surface temperature is long, thus reducing a throughput of a heating section that performs heating in this way;
because each location in the surface to be heated is irradiated with the laser beam at a separate time, the temperature of the whole surface is not well-controlled at one time, which may result in non-uniformities in the tinting density obtained throughout the eyeglass; and
because the laser beam has a finite diameter at the eyeglass surface, an issue is the overlap extent that appears between neighbouring segments of the scan path. Put another way, the uniformity of heat deposition into the irradiated surface acutely depends on the lateral offset value that is implemented between neighbouring scan path segments. Tinting density may then exhibit maxima or minima between pairs of neighbouring scan path segments.

Because of these reasons, heating through laser scanning requires adjustments of process parameters which are difficult and time-consuming.

Starting from this situation, one object of the present invention consists in providing a new method for heating an optical element that alleviates the above-mentioned difficulties.

Another object of the invention consists in providing uniform tinting to an optical element in a more simple and reliable manner compared to known methods.

Still another object of the invention consists in heating an optical element with a reduced unit process time.

### SUMMARY OF THE INVENTION

According to a first aspect of the invention, a method of heating an optical element comprises the following steps, when the optical element has a surface to be heated that is limited by a peripheral edge of this optical element:
/1/ collecting geometry parameters of the optical element; and
/2/ irradiating the surface of the optical element with a laser beam directed onto this surface, fixedly with respect to this latter, through a beam shaping device that is adapted with respect to the geometry parameters of the optical element for providing the laser beam with a transverse power distribution such that irradiation of the surface causes a temperature of this surface to increase up to a maximum temperature distribution that is substantially uniform throughout the surface as limited by the peripheral edge of the optical element.

Thanks to using laser irradiation through the beam shaping device, the whole surface of the optical element can be heated simultaneously, so that process time is reduced. In addition, this avoids adjusting parameters such as scanning speed and pitch of a scan path while directly producing enough uniformity in the temperature increase throughout the whole surface of the optical element.

The invention method especially suits when increasing the temperature in the bulk of the optical element body is unnecessary, but when it is sufficient increasing the temperature of the optical element next to its surface. Then, transferring heat through this surface as involved in the invention method allows increasing the temperature of this surface without heating the whole body of the optical element. Saving in process time also results from such limitation of the temperature increase to part of the optical element next to its surface.

Preferred embodiments of the invention may advantageously implement one or more of the following additional features:
the geometry parameters of the optical element may comprise a diameter relating to the surface of this optical element. In such case, the beam shaping device may be adapted for conferring a flat-top profile to the transverse power distribution of the laser beam at the surface of the optical element during step /2/, and selected so that a diameter of the flat-top profile matches the diameter of the surface of the optical element;
irradiation parameters that are implemented in step /2/ may be selected such that the increased temperature is combined with maintaining a shape of the surface of the optical element unchanged during this step /2/;
the beam shaping device may be such that the transverse power distribution of the laser beam causes absolute temperature differences existing between any two locations throughout the surface of the optical element to be less than 5° C. (degree Celsius), preferably less than 3° C.; more preferably less than 2° C., in the maximum temperature distribution and/or at any time during step /2/;
the laser beam may be produced by an infrared laser source, preferably a near-infrared source, or a UV laser source, that may be of pulsed laser source type but preferably of continuous laser source type such as a CO₂ laser or fiber laser source type. In such case, the laser source may be adapted so that the laser beam has a time-averaged power value of more than 100 W, preferably of between 200 W and 2000 W, more preferably of between 400 W and 1000 W. In particular, 500 W may be a most preferred time-averaged power value for the laser beam used in step /2/;
the beam shaping device may comprise a diffractive optical element or a spatial light modulator;
the laser beam may be directed onto the surface of the optical element during step /2/ substantially parallel to an optical axis of this optical element;
the optical element may be comprised of an eyeglass;
the optical element may be comprised of a resin-type material at least at the surface to be irradiated;
the temperature of the surface of the optical element may be less than 200° C., preferably less than 190° C., more preferably less than 140° C., even more preferably less than 125° C., in the maximum temperature distribution at any location throughout this surface as limited by the peripheral edge of the optical element; and
the optical element may comprise at least one base optical element portion and a polarizing film structure that is adhered to the at least one base optical element portion and extends substantially parallel to the surface of the optical element. Then, the surface to be irradiated in step /2/ may belong to the at least one base optical element portion so that this surface is apart from the polarizing film structure within the optical element.

Improvements of the invention may address configurations of the optical element where its surface to be irradiated has a convex sectional shape within a section plane. For such configurations, the beam shaping device may be such that the transverse power distribution of the laser beam exhibits two maxima separated by an intermediate minimum within the section plane at the surface of the optical element. Then, a difference in power density value of the transverse power distribution of the laser beam between any one of both maxima and the intermediate minimum within the section plane may be determined such as to vary as an increasing function of an absolute curvature value of the surface in the section plane.

Alternative improvements of the invention may address other configurations of the optical element where its surface to be irradiated has a concave sectional shape within the section plane. For such other configurations, the beam shaping device may be such that the transverse power distribution of the laser beam exhibits a single maximum within the section plane at the surface of the optical element. Then, an absolute value of a second radial derivative of the transverse power distribution of the laser beam within the section plane may be determined such as to vary as another increasing function of the absolute curvature value of the surface in the section plane.

First applications of the invention relate to tinting the optical element. Such applications may implement depositing dyes on the surface of the optical element before step /2/. Then, the irradiation of the surface in step /2/ is suitable to produce a fixation of the dyes on or into the optical element. When the optical element is comprised of an organic material at its surface, a wavelength of the laser beam may advantageously be selected within a transparency band of the dyes and also within and absorption band of the organic material. In this way, irradiation of the surface in step /2/ causes the organic material to increase in temperature through absorption of the laser beam, and the dyes to increase in temperature through contact with the organic material. This results in activating an imbibition of the dyes into the organic material from the surface of the optical element, thereby producing permanent fixation of the dyes on or into the optical element. Alternatively, the wavelength of the laser beam may be selected to be within respective absorption bands of both dyes and organic material, so that irradiation of the surface in step /2/ causes both dyes and organic material to increase in temperature through respective absorptions of the laser beam, thereby activating again imbibition of the dyes into the organic material from the surface of the optical element. Generally, the wavelength may be selected so that a total absorption of the laser beam by both dyes and organic material in the optical element is higher than 20%, preferably higher than or equal to 30%, of a total power of the laser beam as impinging on the surface of the optical element. Shorter heating times can then be implemented in step /2/, and power loss due to transmission of the laser beam through the optical element is lower. In particular, the wavelength of the laser beam may be in the near-infrared range, for example substantially equal to 1908 nm or 1064 nm.

In second applications of the invention, the optical element may be comprised of a film structure, possibly a laminated film structure, in particular a polarizing film structure, and step /2/ is executed so as to reduce or suppress internal stresses which exist within the film structure. The invention method can thus be used for performing a stress-relaxing curing, in particular such curing to be implemented with the film structure after this latter has been preformed. Indeed, film preforming may generate stresses within the preformed film structure, which are high enough to impede further use of the film structure.

In third applications of the invention, the optical element may comprise a base optical element which is provided with a varnish layer, in particular a varnish layer that is intended to procure hard coat efficiency. Then, the varnish layer may constitute the surface of the optical element that is irradiated in step /2/, and step /2/ may be executed so as to cross-link the varnish layer or complete a cross-linking thereof. Such third applications of the invention may be advantageous when the optical element is an eyeglass comprised of organic material, or when it incorporates surface layers such as a UV filter or a photochromic layer. Indeed the hard coat efficiency protects the organic material of the eyeglass or the surface layers against abrasion or scratches.

A second aspect of the invention proposes a system for heating an optical element, that comprises:
a laser source; and
a beam shaping device that is arranged so that a laser beam produced by the laser source is transmitted through the beam shaping device and thereafter impinges onto a surface of the optical element.

This invention system is arranged so that the laser beam is directed onto the surface of the optical element fixedly with respect to this surface during a use of the system. In addition, the beam shaping device is adapted, selected or capable to be tuned with respect to geometry parameters of the optical element for providing the laser beam with a transverse power distribution such that irradiation of the surface with this laser beam causes a temperature of the surface to increase up to a maximum temperature distribution that is substantially uniform throughout the surface as limited by a peripheral edge of the optical element. Such system allows one-piece flow with process time per optical element unit which is short.

Possibly, this invention system may comprise multiple diffractive optical elements which are each suitable for forming the beam shaping device when selected based on the geometry parameters of the optical element to be heated. Alternatively, the beam shaping device may comprise a spatial light modulator and a controller which is arranged for controlling the spatial light modulator based on the geometry parameters of the optical element.

The system of the second invention aspect may be adapted for implementing a method that is in accordance with the first invention aspect. In particular, it may further comprise means for receiving the geometry parameters of at least one optical element to be heated, and system sections that are spatially arranged in accordance with the following reciting order: an entrance section, optionally a dye deposition section, an optional pre-curing section, a heating section, and an output section. It also comprises a conveying system that is arranged for transferring the at least one optical element through the system sections in accordance with the previous reciting order, the heating section being adapted for irradiation of the at least one optical element in accordance with the geometry parameters received for this latter, with the laser beam through the beam shaping device, after the at least one optical element has been introduced into the heating section by the conveying system.

A third aspect of the invention provides a tinted optical element, comprising at least one base optical element portion and a polarizing film structure that is bound to the base optical element portion and extends substantially parallel to a surface of the optical element. Within this optical element, the base optical element portion and the polarizing film structure are arranged so that the surface of the optical element is apart from the polarizing film structure, and the optical element further comprises dyes that are fixed on the surface or incorporated within the optical element close to this surface and apart from the polarizing film structure.

Such tinted optical element of the third invention aspect may be a tinted eyeglass.

These and other features of the invention will be now described with reference to the appended figures, which relate to preferred but not-limiting implementations of the invention.

### BRIEF DESCRIPTION OF THE DRAWINGS

FIGS. 1a and 1b illustrate a first implementation of the invention method to heat an eyeglass.

FIG. 2 is a cross-sectional view of an eyeglass possibly used in the first implementation of FIGS. 1a and 1b.

FIGS. 3a and 3b illustrate a second implementation of the invention method to relax stresses existing in a preformed film.

FIG. 4 is a cross-sectional view of a preformed film possibly used in the second implementation of FIGS. 3a and 3b.

FIG. 5 illustrates a third implementation of the invention method to cross-link a varnish layer deposited on an eyeglass.

FIG. 6 illustrates a system arrangement for heating optical elements that is in accordance with the invention.

For clarity sake, element sizes which appear in these figures do not correspond to actual dimensions or dimension ratios. Also, same reference numbers which are indicated in different ones of these figures denote identical elements of elements with identical function.

### DETAILED DESCRIPTION OF THE INVENTION

An optical article according to the disclosure comprises at least one ophthalmic lens or optical filter or optical glass or optical material suitable for human vision, e.g. at least one ophthalmic lens, or optical filter, or optical film each comprising a substrate, or patch intended to be fixed on a substrate, or optical glass, or optical material intended for use in an ophthalmic instrument, for example for determining the visual acuity and/or the refraction of a subject, or any kind of safety device including a safety glass or safety wall intended to face an individual's eye, such as a protective device, for instance safety lenses or a mask or shield.

The optical article may be implemented as eyewear equipment having a frame that surrounds at least partially one or more ophthalmic lenses. By way of non-limiting example, the optical article may be a pair of glasses, sunglasses, safety goggles, sports goggles, a contact lens, an intraocular implant, an active lens with an amplitude modulation such as a polarized lens, or with a phase modulation such as an auto-focus lens, etc.

Herein, the term “lens” means an organic or inorganic glass lens, comprising a lens substrate, which may be coated with one or more coatings of various natures.

The term “ophthalmic lens” is used to mean a lens adapted to a spectacle frame, for example to protect the eye and/or correct the sight. Said lens can be chosen from afocal, unifocal, bifocal, trifocal and progressive lenses. Although ophthalmic optics is a preferred field of the invention, it will be understood that this invention can be applied to optical articles of other types, such as, for example, lenses for optical instruments, in photography or astronomy, optical sighting lenses, ocular visors, optics of lighting systems, safety lenses, etc.

The at least one ophthalmic lens or optical glass or optical material suitable for human vision can provide an optical function to the user i.e. the wearer of the lens.

It can for instance be a corrective lens, namely, a power lens of the spherical, cylindrical and/or addition type for an ametropic user, for treating myopia, hypermetropia, astigmatism and/or presbyopia. The lens can have a constant power, so that it provides power as a single vision lens would do, or it can be a progressive lens having variable power.

A heating system in accordance with the invention comprises a laser source 1 and a beam shaping device 2. It is designed to irradiate the whole surface S of an optical article or element 10, such as an eyeglass. For example, the surface S as limited by a peripheral edge E of the optical element 10 may be below 100 mm (millimeter) in diameter when the optical element 10 is an ophthalmic lens, more preferably comprised between 55 mm and 80 mm, usually close to 70 mm, or above 100 mm, such as 150 mm or 200 mm for example, in case the optical element 10 is a safety mask, for example a one piece safety mask intended to cover both eyes of a subject.

The laser beam as exiting the laser source 1, denoted B, may have a collimated configuration, for example 5 mm in beam diameter. Then, a function of the beam shaping device 2 is to enlarge a cross-sectional diameter of the laser beam so that the whole surface S is impinged with laser radiation originating from the laser source 1. Preferably, the laser beam B′ as outputted by the beam shaping device 2 from the laser beam B may have a diverging configuration downstream the beam shaping device 2, and the optical element 10 is located at a distance from the exit of the beam shaping device 2 suitable for the diverging laser beam B′ to encompass the whole surface S of the optical element 10. For avoiding energy losses, the system is preferably adjusted so that a peripheral limit of the diverging laser beam B′ at the optical element 10 lies beyond the peripheral edge E of the optical element 10 outwardly by a reduced margin only.

The beam shaping device 2 may of any type, including a diffractive optical element, a spatial light modulator, a microscope objective, etc. Spatial light modulators allow adapting a transverse power distribution across the laser beam B′, so as to obtain uniform heating of the surface S of the optical element 10. Temperature differences of less than 5° C. in absolute value between any two locations in the surface S of the optical element 10, as resulting from irradiating this surface S with the laser beam B′ for a determined time period, may be appropriate for some applications. Other applications may require absolute temperature difference values of less than 3° C., even less than 2° C., between any locations in the surface S as limited by the peripheral edge E.

Preferably, a median propagation direction of the laser beam B′ may be superposed to an optical axis of the optical element 10.

For some applications, it may be sufficient providing the laser beam B′ with a uniform power distribution value for meeting the requirement in temperature uniformity throughout the surface S of the optical element 10. Then, the beam shaping device 2 may confer a flat-top profile to the transverse power distribution of laser beam B′ at the distance of the optical element 10 from the exit of the beam shaping device 2.

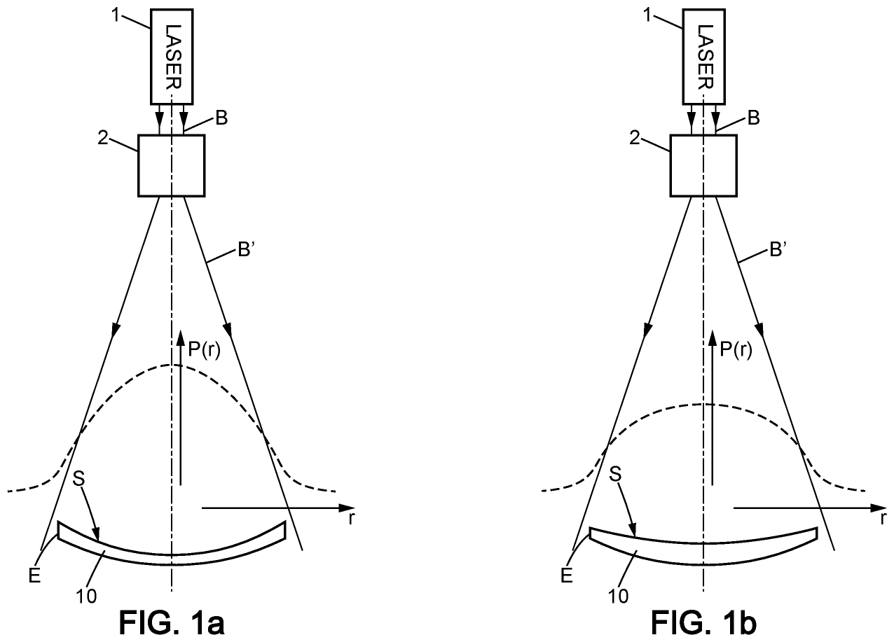

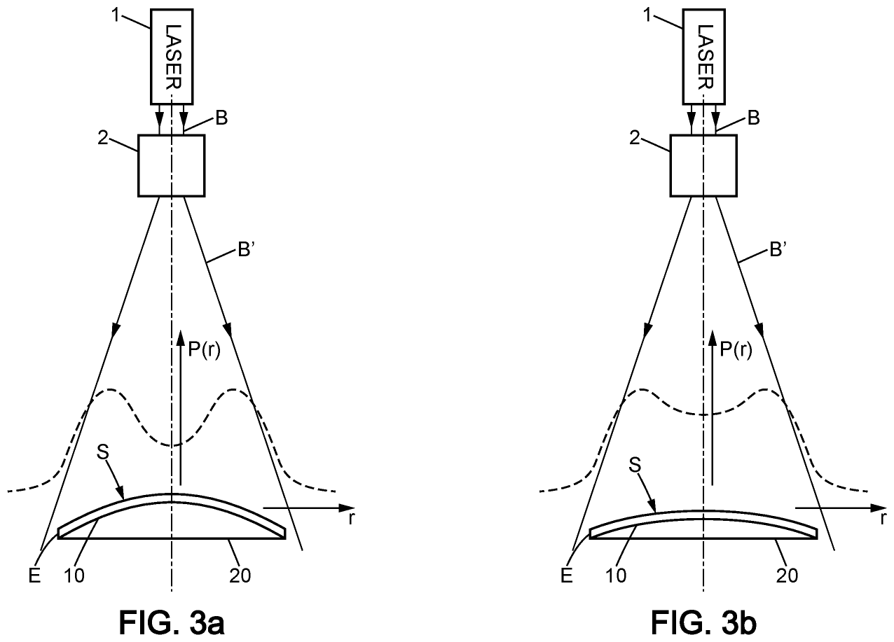

For applications that are more demanding in uniformity of the temperature throughout the surface S, it may be necessary to adapt the transverse power distribution of the laser beam B′ across this surface S. General rules for such adaptation may be the following ones recited for spherical surfaces as non-limiting examples:
if the surface S is concave, the transverse power distribution P(r) expressed as a function of a radial distance r from the median propagation direction of the laser beam B′ should exhibit a maximum located on this median propagation direction and decrease radially for increasing r-values. According to a possible refinement, a second-derivative value of the power distribution P(r) with respect to the radial distance r may be higher in absolute value when the absolute value of the curvature radius of the concave surface S is smaller. Such first variation rule is illustrated by the profiles P(r) as superposed in dash lines to FIGS. 1a and 1b; and
if the surface S is convex, the transverse power distribution P(r) expressed as a function of the radial distance r from the median propagation direction of the laser beam B′ should exhibit two maximum values located on either side of the median propagation direction of the laser beam B′ within each meridian plane, and a minimum value at the median propagation direction of the laser beam B′. According to another possible refinement, a difference between each maximum value of the transverse power distribution P(r) and its minimum value at the median propagation direction may be higher when the absolute value of the curvature radius of the convex surface S is smaller. Such second variation rule is illustrated by the profiles P(r) as superposed in dash lines to FIGS. 3a and 3b.

Such adaptations of the transverse power distribution profile can be easily implemented by using a single spatial light modulator for forming the beam shaping device 2. But it is also possible selecting an appropriate model of beam shaping device based on its fixed transverse power distribution profile with respect to the curvature of the surface S of the optical element 10 to be heated.

However, it may be advantageous using a flat-top profile for the transverse power distribution P(r) for compatibility with a great variety of possible shapes for the surface S. Then a single beam shaping device 2 may be used for a great number of optical elements 10, without selecting an appropriate beam shaping device model for each optical element.

For most applications described thereafter, because the surface S is less than about 120 mm, more preferably less than 80 mm, in diameter and the maximum temperature to be obtained for the surface S is less than 200° C., the laser source 1 may be 500 W in power. Preferably, it may be a continuous or a pulsed power source, and in the latter case, 500 W should then be construed as the time-averaged power value, calculated over time including the pulse durations but also the pulse-separating durations. Generally, it may be an issue that the maximum temperature produced at the surface S through irradiation with the laser beam remains less than a glass temperature of a constituting material of the optical element 10 at its surface S. This ensures that a shape of the surface S is unchanged during heating, so that the optical efficiency of the element 10 is maintained.

Preferably, a wavelength value of the laser source 1 may be selected within an absorption band of the material of the optical element 10, for heating efficiency. Such wavelength value may be in the UV range or the infrared range, since the eyeglass material is transparent in the visible range.

A first application of the invention heating method may be dye impregnation, or dye imbibing, into an eyeglass. Such first application is illustrated in FIGS. 1a and 1b. The eyeglass may include a substrate or a support layer, being comprised of any organic material commonly used in the ophthalmic domain which forms the optical element 10. The substrate or the support layer 10 may in particular be an optically transparent material having the shape of the optical article, for example an ophthalmic lens destined to be mounted in glasses. In this context, the term “substrate” is understood to mean the base constituent material of the optical lens and more particularly of the ophthalmic lens. This material acts as support for a stack of one or more coatings or layers. For example, the substrate may be out of a thermoplastic material such as polycarbonates and thermoplastic polyurethanes, or a thermosetting (cross-linked) material such as diethylene glycol bis(allylcarbonate) polymers and copolymers (in particular CR-39® from PPG Industries), thermosetting polyurethanes, polythiourethanes, preferably polythiourethane resins having a refractive index of 1.60 or 1.67, polyepoxides, polyepisulfides, such as those having a refractive index of 1.74, poly(meth)acrylates (such as PMMA) and copolymers based materials, such as comprising (meth)acrylic polymers and copolymers derived from bisphenol-A, polythio(meth)acrylates, as well as copolymers thereof and blends thereof. Specific examples of eyeglass materials suitable for the present imbibing application of the invention are those obtained from thermosetting polythiourethane resins, which are marketed by Mitsui Toatsu Chemicals company as MR series, in particular MR6®, MR7® and MR8® resins. These materials as well as the monomers used for their preparation are especially described in the patents U.S. Pat. Nos. 4,689,387, 4,775,733, 5,059,673, 5,087,758 and 5,191,055.

Prior to heating the substrate 10, dye particles are deposited on the surface S of this eyeglass, preferably that one of its optical surfaces which is concave as represented in FIGS. 1a and 1b. The dye particles may be deposited on this surface S of a “nude” substrate i.e. on the substrate material itself using one of the following methods known from prior art: dye sublimation and condensation, spin-coating, deposition using an inkjet printer, etc. A thickness of the dye layer thus deposited may be of few micrometers. Then, a heating step is necessary for fixing the dye particles at the surface S of the eyeglass 10, through diffusion of the dye particles into the organic material of the eyeglass 10. Heating causes the lattice of the organic material of the eyeglass to be loosened, thereby promoting diffusion of the dye particles into the eyeglass material from the surface S, so that the dye particles become permanently fixed into the eyeglass 10 next to the surface S.

Preferably, the wavelength value of the laser source 1 may be selected within an absorption band of the organic material of the eyeglass 10, but out of a main absorption band of the dyes. This avoids that direct laser radiation absorption by the dye particles may damage their molecular structure and tinting efficiency.

The irradiation parameters may depend on the material of the eyeglass 10, and the values provided in Table 1 below should be construed as start values for optimization test series:

TABLE 1

| | poly- | | | Refractive |
|---|---|---|---|---|
| | carbonate | MR7/MR8 | ORMA | index = 1.74 |
| Irradiation duration | Few minutes | | | |
| Maximum temperature | 125° C. | 175° C. | 175° C. | 175° C. |
| in surface S at the end | | | | |
| of irradiation duration | | | | |
| Maximum temperature | 2° C. | | | |
| difference within | | | | |
| surface S | | | | |

Alternatively, the wavelength value of the laser source 1 may be selected within an absorption band of the organic material of the eyeglass 10, and simultaneously to be within an absorption band of the dyes. This allows the total absorption value of the eyeglass 10 with the dyes deposited beforehand thereon to be higher. Then, the heating time for the surface S to reach a same maximum temperature can be reduced and/or the power of the laser beam B′ can be less high. For example, values of 1908 nm (nanometers) and 1064 nm are possible alternatively for the emission wavelength of the laser source 1. Commercially available laser sources based on silica fiber doped with thulium (Tm) emit at 1908 nm, and Nd-YAG (neodymium-doped yttrium- and aluminium-garnet) lasers emit at 1064 nm. The following heating features have been obtained with eyeglasses based on diethylene glycol bis(allylcarbonate) polymers and copolymers (CR-39® or ORMA®):

TABLE 2

| Wavelength value | 1908 nm | 1064 nm |
|---|---|---|
| Total absorption of the | More than 50% | More than 20% |
| eyeglass with dyes | | |
| Irradiation duration | 30 s to 60 s | 60 s |

In this table 2, the total absorption is expressed as percent values with respect to the power of the laser beam B′ that is incident onto the surface S supporting the dye layer. The irradiation durations are expressed in seconds.

Dyes of various types may be used, including dyes in liquid phase. As the sublimable dye, which may contain a dissolved or fine-grained dispersed sublimable dye, three dispersion dye inks of red, blue and yellow colors have been used, each being a commercially available water-based ink. These inks were separately filled in commercially available ink cartridges for an inkjet printer. The cartridges were mounted into the inkjet printer, which is a commercially available printer in the present implementation. Table 3 below compares the absorption values of the eyeglass 10 without and with dyes deposited thereon for two different types of eyeglasses:

TABLE 3

| Wavelength values | 1908 nm | 1064 nm |
|---|---|---|
| Polycarbonate-based eyeglass 10 | 39% | 7.5% |
| without dyes | | |
| Polycarbonate-based eyeglass 10 | 51% | 29% |
| with dyes | | |
| ORMA ® eyeglass 10 without dyes | 79% | 6.6% |
| ORMA ® eyeglass 10 with dyes | 83% | 23% |

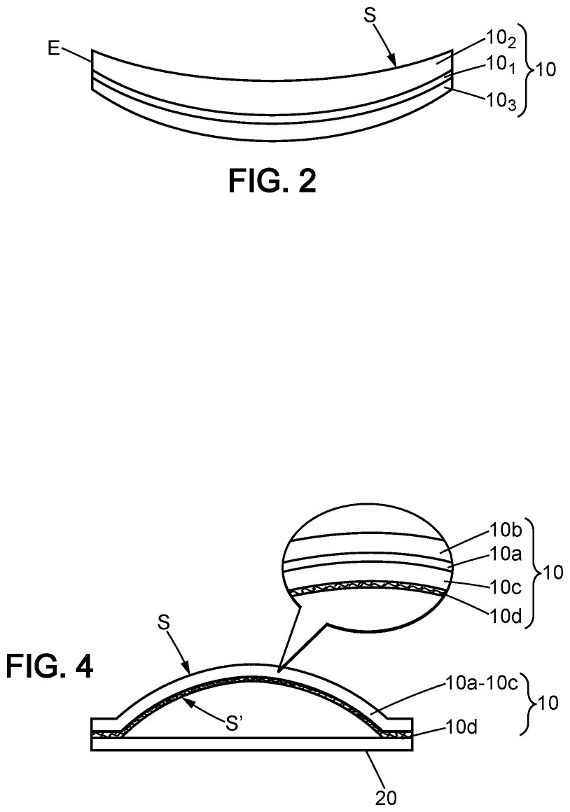

A particular advantage of the invention heating method relates to a substrate to be heated that incorporates a film structure when this film structure may be damaged by excessive temperature. Such case is an eyeglass that has a laminated configuration for incorporating a polarizing film structure, as shown in FIG. 2. The eyeglass 10 comprises the polarizing film structure 101, a first base optical element portion 102 and a second base optical element portion 103. The polarizing film structure 101 is laminated between the base optical element portions 102 and 103, and permanently adhered to both of them. The base optical element portion 102 forms the surface S to be heated, for example for imbibing dyes therein. Both base optical element portions 102 and 103 may be of any one of the materials listed above. In such configuration, the surface S to be irradiated and so heated is apart from the polarizing film structure 101, so that the temperature of this latter structure 101 remains lower than that of the surface S being irradiated. In this way, any material of the polarizing film structure 101 which could be damaged by a temperature equal to the maximum one of the surface S is saved. Most polarizing film structures comprise a polyvinyl acetate (PVA) film laminated between two protecting films, for example two triacetate cellulose (TAC) protecting films, and the PVA film is sensitive to excessive temperature.

An interferential coating (antireflective or reflective coating) may be deposited directly onto the dyed substrate. It is preferred usually that the main surface of the substrate be coated with one or more functional coatings improving its optical and/or mechanical properties, prior to depositing the reflective coating of the invention. These functional coatings traditionally used in optics may be, without limitation, an impact-resistant primer layer, an abrasion- and/or scratch-resistant coating (hard coat), a polarized coating, an antistatic coating, a photochromic coating, a tinted coating or a stack made of two or more of such coatings.

The impact-resistant primer coating which may be used in the present invention can be any coating typically used for improving impact resistance of a finished optical article. By definition, an impact-resistant primer coating is a coating which improves the impact resistance of the finished optical article as compared with the same optical article but without the impact-resistant primer coating.

Typical impact-resistant primer coatings are (meth)acrylic based coatings and polyurethane based coatings. In particular, the impact-resistant primer coating according to the invention can be made from a latex composition such as a poly(meth)acrylic latex, a polyurethane latex or a polyester latex.

Preferred primer compositions include compositions based on thermoplastic polyurethanes, such as those described in the patents JP 63-141001 and JP 63-87223, poly(meth)acrylic primer compositions, such as those described in the patents U.S. Pat. Nos. 5,015,523 and 6,503,631, compositions based on thermosetting polyurethanes, such as those described in the patent EP 0 404 111 and compositions based on poly(meth)acrylic latexes or polyurethane latexes, such as those described in the patents U.S. Pat. No. 5,316,791 and EP 06 80 492. Preferred primer compositions are compositions based on polyurethanes and compositions based on latexes, in particular polyurethane latexes, poly(meth)acrylic latexes and polyester latexes, as well as their combinations. In one embodiment, the impact-resistant primer comprises colloidal fillers.

Poly(meth)acrylic latexes are latexes based on copolymers essentially made of a (meth)acrylate, such as for example ethyl (meth)acrylate, butyl (meth)acrylate, methoxyethyl (meth)acrylate or ethoxyethyl (meth)acrylate, with at least one other co-monomer in a typically lower amount, such as for example styrene.

Commercially available primer compositions suitable for use in the invention include the Witcobond® 232, Witcobond® 234, Witcobond® 240, Witcobond® 242 compositions (marketed by BAXENDEN CHEMICALS), Neorez® R-962, Neorez® R-972, Neorez® R-986 and Neorez® R-9603 (marketed by ZENECA RESINS), and Neocryl® A-639 (marketed by DSM coating resins).

The thickness of the impact-resistant primer coating, after curing, typically ranges from 0.05 to 30 μm, preferably 0.2 to 20 μm and more particularly from 0.5 to 10 μm, and even better 0.6 to 5 μm or 0.6 to 3 μm, and most preferably 0.8 to 1.5 μm.

The impact-resistant primer coating is preferably in direct contact with an abrasion- and/or scratch-resistant coating.

The abrasion- and/or scratch-resistant coating may be any layer traditionally used as an anti-abrasion and/or anti-scratch coating in the field of optical lenses.

The abrasion- and/or scratch-resistant coatings are preferably hard coatings based on poly(meth)acrylates or silanes, generally comprising one or more mineral fillers intended to increase the hardness and/or the refractive index of the coating once cured.

Abrasion- and/or scratch-resistant coatings are preferably prepared from compositions comprising at least one alkoxysilane and/or a hydrolyzate thereof, obtained for example through hydrolysis with a hydrochloric acid solution and optionally condensation and/or curing catalysts.

Suitable coatings that are recommended for the present invention include coatings based on epoxysilanes and/or epoxysilanehydrolyzates such as those described in the patents EP 0 614 957, U.S. Pat. Nos. 4,211,823 and 5,015,523.

A preferred abrasion- and/or scratch-resistant coating composition is disclosed in the patent EP 0 614 957, in the name of the applicant. It comprises a hydrolyzate of epoxy trialkoxysilane and dialkyl dialkoxysilane, colloidal silica and a catalytic amount of an aluminum-based curing catalyst such as aluminum acetylacetonate, the rest being essentially composed of solvents traditionally used for formulating such compositions. Preferably, the hydrolyzate used is a hydrolyzate of g-glycidoxypropyltrimethoxysilane (GLYMO) and dimethyldiethoxysilane (DMDES).

The abrasion- and/or scratch-resistant coating composition may be deposited by known methods and is then cured, preferably using heat or ultraviolet radiation. The thickness of the (cured) abrasion- and/or scratch-resistant coating does generally vary from 2 to 10 μm, preferably from 3 to 5 μm.

Prior to depositing the interferential coating or other functional coatings, the surface of the article is usually submitted to a physical or chemical surface activating and cleaning pre-treatment, so as to improve the adhesion of the layer to be deposited, such as disclosed in WO 2013/013929. This pre-treatment is generally performed on the surface of an abrasion- and/or scratch-resistant coating (hard coat).

This pre-treatment is generally carried out under vacuum. It may be a bombardment with energetic species, for example an ion beam bombardment (“Ion Pre-Cleaning” or “IPC”) or an electron beam treatment, a corona treatment, an ion spallation treatment, an ultraviolet treatment or a plasma treatment under vacuum, using typically an oxygen or an argon plasma. It may also be an acid or a base surface treatment and/or a solvent surface treatment (using water or an organic solvent) with or without ultrasonic treatment. Many treatments may be combined. Thanks to these cleaning treatments, the cleanliness of the substrate surface is optimized.

By energetic species, it is meant species with an energy ranging from 1 to 300 eV (electron-volt, 1 eV=1.6·10⁻¹⁹ Joule), preferably from 10 to 150 eV, and most preferably from 40 to 150 eV. Energetic species may be chemical species such as ions, radicals, or species such as photons or electrons.

The preferred pre-treatment is an ion bombardment, for example by using an ion gun-generated argon ion beam.

The interferential coating may be any interferential coating conventionally used in the field of optics, in particular ophthalmic optics. The interferential coating may be, in a non-limiting manner, an anti-reflection coating or a reflective (mirror) coating.

The optical article according to the invention may also comprise coatings formed on the reflective coating and capable of modifying the surface properties thereof, such as a hydrophobic and/or oleophobic coating (antifouling top coat). These coatings are preferably deposited onto the outer layer of the reflective coating. Generally, their thickness is lower than or equal to 10 nm, does preferably range from 1 to 10 nm, more preferably from 1 to 5 nm. Antifouling top coats are generally coatings of the fluorosilane or fluorosilazane type, preferably comprising fluoropolyether moieties and more preferably perfluoropolyether moieties. More detailed information on these coatings is disclosed in WO 2012/076714.

Instead of a hydrophobic coating, a hydrophilic coating may be used which provides anti-fog properties (anti-fog coating), or a precursor of an anti-fog coating which provides anti-fog properties when associated with a surfactant. Examples of such anti-fog precursor coatings are described in the patent application WO 2011/080472.

The additional coatings such as primers, hard coats and antifouling top coats may be deposited onto a main face of the substrate using methods known in the art, including spin-coating, dip-coating, spray-coating, evaporation, sputtering, chemical vapor deposition and lamination.

Typically, an optical article according to the invention comprises a substrate on which dyes are deposited and fixed by laser surface heating, said dyed substrate being then successively coated with an impact-resistant primer layer, an anti-abrasion and/or scratch-resistant layer, an interferential coating according to the invention, and a hydrophobic and/or oleophobic coating, or a hydrophilic coating that provides anti-fog properties, or an anti-fog precursor coating.

A second application of the invention heating method may be stress-relaxation within a film structure. Such second application is illustrated in FIGS. 3a and 3b. The film structure which forms now the optical element 10 may have been preformed, for example for being adhered later to a curved face of an eyeglass, such as a substrate as defined in relation with the first application, incorporating dyes according to said first application, or not, in particular such convex face. When intended to be combined with an eyeglass in this way, the film structure 10 is commonly called patch in the art. The process implemented for preforming the film structure 10 is not the subject-matter of the present invention, and any such process known in the art may be used. But preforming generates residual stresses within the film structure 10 which may cause deformation of the eyeglass during a further processing step. It is therefore necessary to relax the internal stresses that exist within the film structure 10 after it has been preformed. FIG. 4 shows an example of such preformed film structure 10. For example, it is a laminated polarizing film structure that comprises a PVA film 10a intermediate between two TAC protecting films 10b and 10c. The PVA film 10a is adhered to both TAC protecting films 10b and 10c, and the film structure 10 may further comprise an adhesive material layer 10d on its concave face S′. This adhesive material may be a pressure-sensitive material, but other types are also possible. It is exposed so that it can trap any dust particle it gets into contact with, and such dust particle cannot be removed thereafter. For avoiding this dust problem, a peripheral margin of the concave face S′ of the film structure 10 may be sealed to a planar screen layer 20 so that the adhesive material layer 10d is no longer exposed. Hence, the convex surface S of the film structure 10 remains exposed.

The combination of the film structure 10 and screen layer 20 is then subjected to the laser beam B′ with the convex surface S of the film structure 10 oriented toward the beam shaping device 2 as shown in FIGS. 3a and 3b. Suitable parameters are irradiation duration of one or several tens of minutes and maximum temperature for the surface S at the end of the irradiation duration of about 120° C. for obtaining sufficient stress relaxation. These values should be construed again as start values for optimization test series. The maximum temperature difference within the surface S at the end of such heating may be less than 5° C.

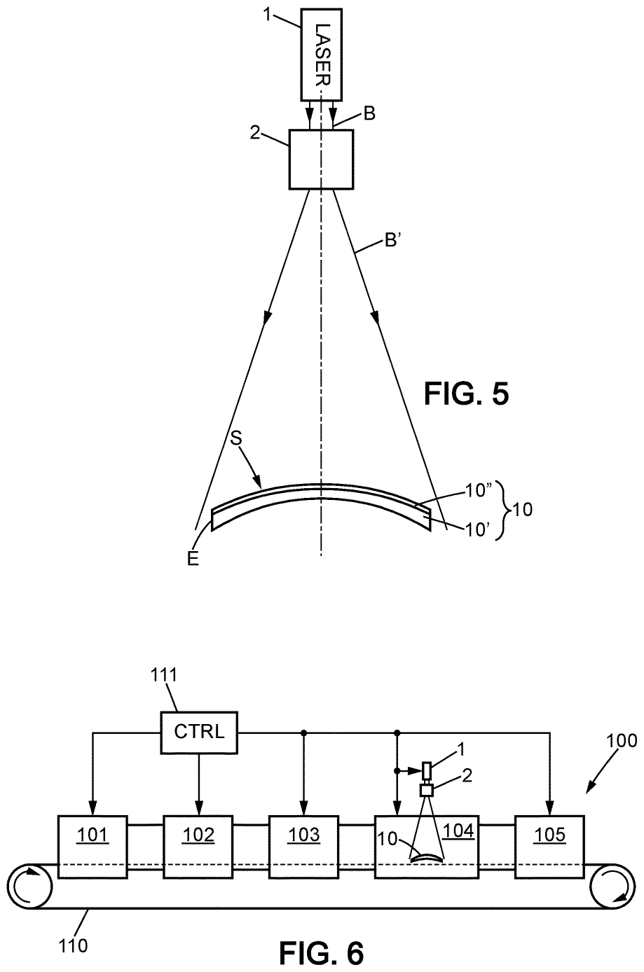

A third application of the invention heating method may be curing of a varnish layer supported by an eyeglass. Such third application is illustrated in FIG. 5. The optical element 10 is now comprised of a base eyeglass 10′ such as a substrate or a support film, and a varnish layer 10″ that coats the convex face thereof. The base eyeglass 10′ may be of any substrate material already recited in connection with the first application, but it may further comprise an impact resistant primer coating as disclosed in connection with the first application, a UV filter varnish and/or a photochromic varnish layer at least on its convex face. The base eyeglass 10′ may also have a laminated structure as shown in FIG. 2. The varnish is intended to form a superficial layer that is resistant to abrasion and/or scratch once it has been cured. Because of this, the cured varnish layer is usually called hard coat. Such hard coat may be as already disclosed in relation with the first application, based on poly(meth)acrylates or silanes, generally comprising one or more mineral fillers intended to increase the hardness and/or the refractive index of the coating once cured. The varnish used for forming such hard coat may be prepared from compositions comprising at least one alkoxysilane and/or a hydrolyzate thereof, obtained for example through hydrolysis with a hydrochloric acid solution and optionally condensation and/or curing catalysts. In particular, suitable varnishes are based on epoxysilanes and/or epoxysilanehydrolyzates such as those described in the patents EP 0 614 957, U.S. Pat. Nos. 4,211,823 and 5,015,523. A preferred hard coat composition is disclosed in the patent EP 0 614 957, that comprises a hydrolyzate of epoxy trialkoxysilane and dialkyl dialkoxysilane, colloidal silica and a catalytic amount of an aluminum-based curing catalyst such as aluminum acetylacetonate, the remainder being essentially composed of solvents commonly used for formulating such compositions. Preferably, the hydrolyzate used is a hydrolyzate of γ-glycidoxypropyltrimethoxysilane (GLYMO) and dimethyldiethoxysilane (DMDES). The varnish composition that is intended to form the hard coat after curing may be deposited on the base eyeglass 10′ so as to form a layer with final thickness value of between 2 μm (micrometer) and 10 μm, preferably from 3 μm to 5 μm, after curing. Curing produces cross-linking within the varnish layer, thereby providing abrasion and/or scratch resistance. Heating that is limited to a superficial part of the optical element 10, including the varnish layer 10″, is advantageous since it results in process time reduction and avoids damaging temperature-sensitive materials that may be incorporated within the base eyeglass 10′. When heating the varnish layer 10″ using the laser source 1 and the beam shaping device 2 as shown in FIG. 5, the face of the optical element 10 that is formed by the varnish layer 10″ is oriented toward the beam shaping device 2. Suitable parameters are irradiation duration of one or several tens of minutes and maximum temperature at the end of irradiation duration of about 110° C. for obtaining appropriate cross-linking. These values should be construed again as start values for optimization test series. The maximum temperature difference within surface S at the end of such heating may be less than 5° C.

The varnish layer cured according to the third application, can then be submitted to a physical or chemical surface activating and cleaning pre-treatment, and/or be covered by other functional coatings such as interferential coatings, a polarized coating, an antistatic coating, a photochromic coating, a tinted coating or a stack made of two or more of such coatings, and/or coatings formed on the interferential coating and capable of modifying the surface properties thereof, such as a hydrophobic and/or oleophobic coating (antifouling top coat), as disclosed in connection with the first application.

FIG. 6 shows a possible arrangement 100 for the invention heating system which may suit for mass-production, but which is of a particular interest for prescription- or Rx-production of optical elements such as eyeglasses, since the latter are produced by orders individually and would benefit from a one-piece flow process. This arrangement 100 comprises several system sections 101-105 which are combined with a conveying system 110. The conveying system 110, for example a belt conveying system, is configured for continuously transferring optical elements 10, from one of the sections to the next one, according to a chained process flow. This process flow may be a one-piece flow where a single optical element 10 is being processed at one time within each system section, or a batch-flow where successive sets of several optical elements 10 are in each system section at one time. For example, each system section may be dedicated to the following process step:
section 101: entrance section, for example provided with an air flow for avoiding dust particles to go into the successive system sections,
sections 102 and 103: processing sections, depending on the application,
section 104: heating section, dedicated to implement the invention heating method and provided with the laser source 1 and the beam shaping device 2, and
section 105: exit section, for example also provided with an air flow for avoiding dust particles to go into the system sections.

For the first application of the invention described above, namely dye-imbibition, at least one of the sections 102 and 103 may be dedicated to deposition of the dye particles on the optical elements 10, for example using a sublimation deposition process.

For the second application of the invention, i.e. application to stress-relaxation in film structures, the sections 102-104 may be each provided with the suitable means for implementing the invention heating method, for the arrangement 100 to have a sufficient production throughput.

For the third application of the invention, i.e. application to varnish cross-linking, the sections 102-103 may be dedicated to pre-curing of the varnish, for example using furnace sections or sections provided with irradiating infrared lamps. Indeed, the varnish layer may need to be heated first up to an intermediate temperature that is lower than that of the cross-linking step. Because this intermediate temperature is low, pre-curing using standard heating systems such as furnace or infrared lamps remain compatible with sufficient throughput of the system arrangement 100.

The system arrangement 100 further comprises a controller 111 configured for receiving geometry parameters of the optical elements 10 to be loaded into the system arrangement, and for transmitting operating parameters and control commands to the laser source 1, possibly the beam shaping device 2 when of spatial light modulator type, the conveying system 110 and possibly at least one of the sections 101-103 and 105.

Obviously, additional system sections may be added in the arrangement 100 depending on the application that implements the invention heating method. The Man skilled in industrial processes knows how to design and configure such system arrangement for meeting targeted properties for the optical elements produced while maximizing its throughput.

It is repeated again that all numeral values which have been cited herein were provided only for exemplifying purpose and may be adapted depending on each application of the invention and the optical elements to be heated. However, these values may be used as start points for tuning trials.

Obviously, the invention heating method may be implemented for applications other than those which have been described in detail, and the invention benefits mentioned herein or others will still apply.

1. A method of heating an optical element, the optical element having a surface to be heated that is limited by a peripheral edge of said optical element, and the method comprises the following steps:
/1/ collecting geometry parameters of the optical element; and
/2/ irradiating the surface of the optical element with a laser beam, wherein the laser beam is directed onto the surface of the optical element in step /2/ fixedly with respect to said surface, through a beam shaping device that is adapted with respect to the geometry parameters of the optical element for providing the laser beam with a transverse power distribution such that irradiation of the surface in step /2/ causes a temperature of said surface to increase up to a maximum temperature distribution that is substantially uniform throughout said surface as limited by the peripheral edge of the optical element.

2. The method of claim 1, wherein the geometry parameters of the optical element comprise a diameter relating to the surface of said optical element.

3. The method of claim 2, wherein the beam shaping device is adapted for conferring a flat-top profile to the transverse power distribution of the laser beam at the surface of the optical element during step /2/, and selected so that a diameter of the flat-top profile matches the diameter of the surface of said optical element.

4. The method of claim 1, wherein irradiation parameters that are implemented in step /2/ are selected such that the increased temperature is combined with maintaining a shape of the surface of the optical element unchanged during said step /2/.

5. The method of claim 1, wherein the laser beam is produced by a laser source, preferably of continuous laser source type, that is an infrared or UV laser source.

6. The method of claim 5, wherein the laser source is adapted so that the laser beam has a time-averaged power value of more than 100 W, preferably of between 200 W and 2000 W, more preferably of between 400 W and 1000 W.

7. The method of claim 1, wherein the optical element is comprised of an eyeglass.

8. The method of claim 1, wherein the temperature of the surface of the optical element is less than 200° C., preferably less than 190° C., more preferably less than 140° C., even more preferably less than 125° C., in the maximum temperature distribution at any location throughout said surface as limited by the peripheral edge of the optical element.

9. The method of claim 1, wherein the optical element comprises at least one base optical element portion and a polarizing film structure that is adhered to said at least one base optical element portion and extends substantially parallel to the surface of the optical element, and wherein said surface which is irradiated in step /2/ belongs to the at least one base optical element portion, so that said surface is apart from the polarizing film structure within the optical element.

10. The method of claim 1, wherein dyes have been deposited on the surface of the optical element before step /2/, and the irradiation of said surface in step /2/ is suitable to produce a fixation of the dyes on the optical element or into said optical element.

11. The method of claim 10, wherein the optical element is comprised of an organic material at the surface of said optical element, and wherein a wavelength of the laser beam is selected to be within a transparency band of the dyes and also within and absorption band of the organic material, so that irradiation of the surface in step /2/ causes the organic material to increase in temperature through absorption of the laser beam, and the dyes to increase in temperature through contact with the organic material, thereby activating an imbibition of the dyes into the organic material from the surface of the optical element.

12. The method of claim 10, wherein the optical element is comprised of an organic material at the surface of said optical element, and wherein a wavelength of the laser beam is selected to be within respective absorption bands of both dyes and organic material, so that irradiation of the surface in step /2/ causes both dyes and organic material to increase in temperature through respective absorptions of said laser beam, thereby activating an imbibition of the dyes into the organic material from the surface of the optical element.

13. The method of claim 11, wherein the wavelength of the laser beam is selected so that a total absorption of said laser beam by both dyes and organic material in the optical element is higher than 20%, preferably higher than or equal to 30%, of a total power of said laser beam as impinging on the surface of said optical element.

14. The method of claim 13, wherein the wavelength of the laser beam substantially equals 1908 nm or 1064 nm.

15. The method of claim 1, wherein the optical element is comprised of a film structure, possibly a laminated film structure, in particular a polarizing film structure, and step /2/ is executed so as to reduce or suppress internal stresses existing within the film structure.

16. The method of claim 1, wherein the optical element comprises a base optical element provided with a varnish layer, in particular a varnish layer intended to procure hard coat efficiency, and wherein the varnish layer constitutes the surface of the optical element that is irradiated in step /2/, and step /2/ is executed so as to cross-link the varnish layer or complete a cross-linking of said varnish layer.

17. A system for heating an optical element, comprising:
a laser source; and
a beam shaping device arranged so that a laser beam produced by the laser source is transmitted through the beam shaping device and thereafter impinges onto a surface of the optical element,
wherein the system is arranged so that the laser beam is directed onto the surface of the optical element fixedly with respect to said surface during a use of said system, and the beam shaping device is adapted, selected or capable to be tuned with respect to geometry parameters of the optical element for providing the laser beam with a transverse power distribution such that irradiation of the surface with said laser beam causes a temperature of said surface to increase up to a maximum temperature distribution that is substantially uniform throughout said surface as limited by a peripheral edge of the optical element.

18. The system of claim 17, comprising means for receiving the geometry parameters of at least one optical element to be heated, and further comprising system sections spatially arranged in accordance with the following reciting order: an entrance section, optionally a dye deposition section, an optional pre-curing section, a heating section, and an output section, and further comprising a conveying system arranged for transferring the at least one optical element through the system sections in accordance with said reciting order, the heating section being adapted for irradiation of the at least one optical element in accordance with the geometry parameters received for said at least one optical element, with the laser beam through the beam shaping device, after the at least one optical element has been introduced into said heating section by the conveying system.

19. A tinted optical element, comprising at least one base optical element portion and a polarizing film structure that is bound to the base optical element portion and extends substantially parallel to a surface of the optical element, wherein the base optical element portion and the polarizing film structure are arranged so that the surface of the optical element is apart from the polarizing film structure, and the optical element further comprises dyes that are fixed on said surface or incorporated within the optical element close to said surface and apart from the polarizing film structure.
